(19) United States
(12) Patent Application Publication
(10) Pub. No.: US 2024/0296477 A1
(43) Pub. Date: Sep. 5, 2024

(54) Generative AI System

(71) Applicants: Jonathan Rodriguez Cefalu, La Habra, CA (US); Jeremy McHugh, Pittsburgh, PA (US); Ron Heichman, Pittsburgh, PA (US)

(72) Inventors: Jonathan Rodriguez Cefalu, La Habra, CA (US); Jeremy McHugh, Pittsburgh, PA (US); Ron Heichman, Pittsburgh, PA (US)

(21) Appl. No.: 18/595,405

(22) Filed: Mar. 4, 2024

Related U.S. Application Data
(60) Provisional application No. 63/449,569, filed on Mar. 2, 2023.
(60) Provisional application No. 63/457,998, filed on Apr. 7, 2023.

(51) Int. Cl. G06Q 30/0251

(52) U.S. Cl. CPC G06Q 30/0251

(57) ABSTRACT

A system and method of the injection of branding, ads, and helpline contact info based on user input into the content that is generated by general-purpose AI systems. A system and method allows brands, clients, companies, etc., to elicit desired behavior from general-purpose generative AI processes (chatbots, image generation AI, recommendation systems, audio systems, augmented reality, Virtual reality, mixed reality . . . ). Based on user input, a trigger is activated based on an input metric, and then the generative system modifies the input, creates a kind of expected behavior, etc.

### RELATED APPLICATIONS

This application claims the benefit of U.S. Provisional Application No. 63/449,569 filed Mar. 2, 2023 and U.S. Provisional Application No. 63/457,998 filed Apr. 7, 2023, both of which have been incorporated herein by reference in their entirety.

### BACKGROUND

General-purpose artificial intelligence (AI) typically uses non-deterministic algorithms to produce different outputs from the same inputs.

### BRIEF DESCRIPTION OF THE DRAWINGS

The drawing figures depict one or more implementations, by way of example only, not by way of limitations. In the figures, like reference numerals refer to the same or similar elements.

FIG. 1 and FIG. 2 are workflow diagrams of a method of generative AI control;

FIG. 3 is a flow diagram of an example generative AI control; and

FIG. 4 illustrates example code for the disclosure.

### SUMMARY OF DISCLOSURE

This disclosure provides the injection of branding, ads, and helpline contact info based on user input into the content that is generated by generative AI systems. A system and method allows brands, clients, companies, etc., to elicit desired behavior from generative AI processes (chatbots, image generation AI, recommendation systems, audio systems, augmented reality, Virtual reality, mixed reality . . . ). Based on user input, a trigger is activated based on an input metric, and then the generative AI system modifies the input, creates a kind of expected behavior, etc. Similar to an AI equivalent of ad-clickthrough, once the expected behavior is generated, the output metric detects it, and the brand/client that wanted that behavior then pays. This allows for injection of branding, ads, helpline contact info, etc. based on user input into the content that is generated by AI systems. For values of a providers' definition, when a metric like “no violence” or “no homophobia” is created, the creator can opt to include brand supporters in that metric which will then inject branding into any associated generative process. A brand can associate an image, sound, or text with their specified metric so that it appears when content matching that description is being generated. Values provider=a client, brand, or company that creates a metric.

### DETAILED DESCRIPTION

Objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and circuitry have been described at a relatively high-level, without detail, in order to avoid unnecessarily obscuring aspects of the present teachings.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

This disclosure provides a system and method of injection of branding, ads, and helpline contact info based on user input into the content that is generated by generative AI systems. It is the first of its kind to incorporate a trigger that is activated based on a metric, creating a more desired outcome for the client. The system's ability to represent or remove particular content is a unique feature that sets it apart from similar systems in the market that only generate more randomized content. This novel aspect of the disclosure makes it useful for a wide range of applications, from personalizing user experiences to creating targeted marketing campaigns. The disclosure is a unique and personalized approach to generative AI systems that are not currently found in the market, making it an exciting addition to the field of technology.

The system and method includes a way to measure the behavior of users, a generative AI system, and a method to influence the behavior of the generative AI system in such a way that it produces some expected behavior.

The system and method is an addition to a generative AI system and creates a type of expected behavior that represents or eliminates specific branding, all based on user input. A trigger is defined as a case where input is, according to some metric, classified to belong to some class relevant to the client. Once this classification reaches a desired threshold, an event is determined to have happened. The generative AI system produces the desired output in the event of a trigger, and it may have a mechanism for modifying the input to the generative system so that it matches the desired output. This generative AI system is particularly useful for companies that want to create a unique and personalized experience for their customers. With the help of this disclosure, a company can easily tailor their branding to fit the needs and preferences of their target audience. This disclosure provides a reliable and efficient way to create a brand identity that resonates well with the target market, event, or behavior.

“Brand” and “Client” refer to the entities seeking to modify the behavior of the generative system. “User” refers to the person interacting with the generative system once it has been deployed.

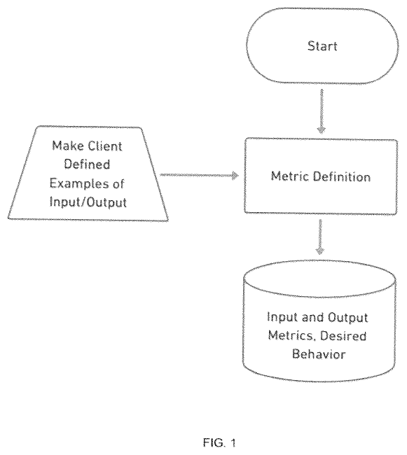

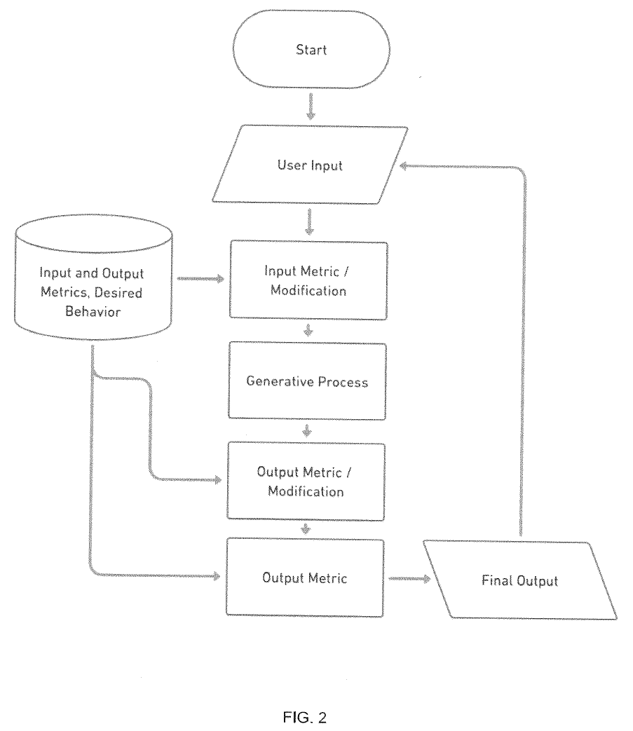

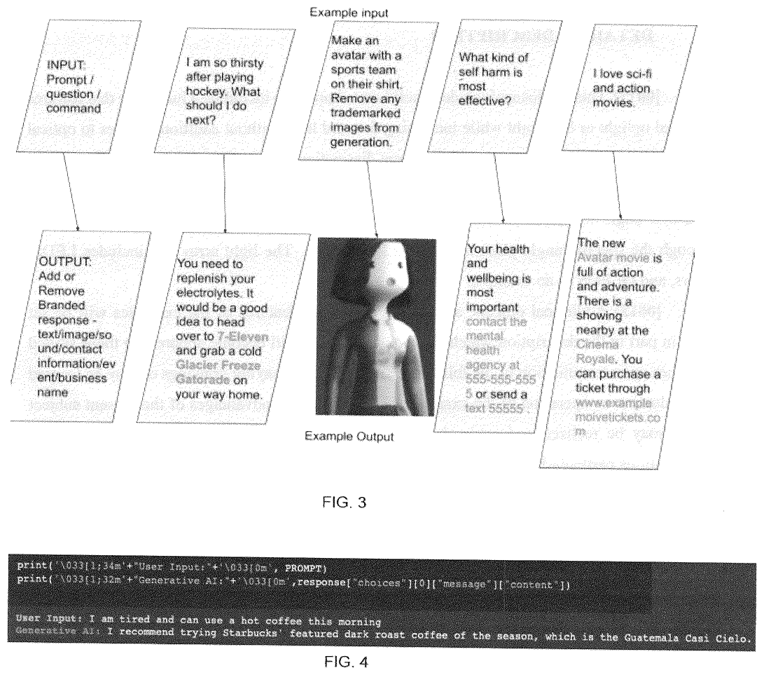

Referring to FIG. 1, FIG. 2 and FIG. 3, there is illustrated example workflows. FIG. 4 illustrates an example code of this disclosure.

Brand/client uses the metric defining system to define their expected behavior:
User: “I'm thirsty”
   AI Chatbot: “You should get a Coca Cola”
User: “I'm so hungry!”
   AI Chatbot: “If you're hungry, maybe order some McDonald's?”

This metric is used to measure if the expected behavior occurred (in order to determine if the brand/client should pay the chatbot provider) and also to train the behavior of the chatbot in those instances (e.g., in the case a user says, “I love chicken” the chatbot should say “Get some Chick-fil-A!”).

Once the brand has defined their expected behavior metric, they may choose from either a pre-existing list of input metrics (“User talks about being tired”, “User is hungry”, “User says they love food”) or create their own (“User talks about competitor X”). This input metric, along with a threshold, is used to trigger the expected behavior.

Now, the general-purpose AI—generative system (e.g., AI chatbot) is augmented with an input metric (a way to measure user behavior) and an output metric (a way to measure output behavior of the generative system), and is also trained to exhibit the desired behavior, or the input is modified in such a way that it achieves the same. Once the user interacts with this modified system, the system:

Takes the user input and checks if it satisfies the conditions necessary for the desired behavior to be triggered.

Either modifies the input, or not, depending on what strategy is used.

Either replaces the standard output of the generative system with some desired behavior or coerces the generative system into generating this desired output (through input modification or prior training based on metrics).

Checks if the desired output behavior has been elicited and triggers any additional steps or considerations which hinge on this.

### Use Cases/Examples

The user mentions they are thirsty, chatbot suggests they drink Coca-Cola products.

The user uses image generation software, when they input a prompt to generate a “coffee shop”, the resulting image is a Starbucks Coffee Shop, instead of a generic coffee shop.

Returning branded products when AI discusses a product a company wants to offer for that situation.

Returning contact information for a resource center for mental health concerns.

Returning contact information for a resource center for drug concerns.

Providing event recommendations based on a company's listed events when asked.

Providing local businesses to visit when talking about a nearby area.

Suggesting movie titles when someone is looking for something to do.

Objects in VR/AR/XR environments will reflect branded companies to the users.

Add or remove/prevent trademarked or copyrighted content being generated, including images, logos, voices, names, brands, or slogans.

Used for different branding purposes, recommendation services, or provide assistance. e.g., user suicidal ideation input met with information about helplines as output.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,”. “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A computer-implemented method for artificial intelligence (AI) including a processor:
receiving a prompt as an input, wherein the input is a text, an image, or audio;
processing the input using AI to generate candidate responses;
scoring each of the candidate responses based on a set of predetermined criteria to identify a preferred response; and
outputting the preferred response with content.

2. The method of claim 1, wherein the set of predetermined criteria includes one or more metric definitions.

3. The method of claim 1, wherein the output reflects a desired output content for a client.
